(19) United States
(12) Patent Application Publication
(10) Pub. No.: US 2026/0172486 A1
(43) Pub. Date: Jun. 18, 2026

(54) DISTRIBUTED BLOCKCHAIN FOR MAINTAINING OPERATOR IDENTIFIER INFORMATION

(71) Applicant: Verizon Patent and Licensing Inc., Basking Ridge, NJ (US)

(72) Inventors: Raghuram Parvataneni, Frisco, TX (US); Parry C. Booker, Sunnyvale, TX (US); Mahesh Chapalamadugu, Plano, TX (US)

(21) Appl. No.: 18/978,029

(22) Filed: Dec. 12, 2024

(51) Int. Cl. H04L 67/63; H04L 9/00

(52) U.S. Cl. CPC H04L 67/63; H04L 9/50

(57) ABSTRACT

One or more computing devices, systems, and/or methods for a distributed blockchain that maintains operator identifier information are provided. A network operator generates a transaction to associate mobile code information with user equipment identifier information as the operator identifier information. The transaction is executed against a blockchain of nodes representing network operators. A smart contract of the blockchain is used to validate the transaction. In response to validating the transaction, the mobile code information and the user equipment identifier information is appended to the blockchain for use by an aggregator for determining how to route API requests to network operators.

### BACKGROUND

A network operator may manage a network over which user equipment can connect and communicate. The network may include various devices, radios and base stations, transport components, core sites, and/or other network equipment. The network operator may track behavior of the network and/or network traffic of calls and data being routed through the network. The tracked network information may be used to adjust operation of the network, identify problems, and resolve issues.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 illustrates an example of a system for a distributed blockchain for maintaining operator identifier information, in accordance with an embodiment of the present technology;

FIG. 2 illustrates an example of a method for maintaining operator identifier information, in accordance with an embodiment of the present technology;

FIG. 3 illustrates an example of a system for a distributed blockchain for maintaining operator identifier information, in accordance with an embodiment of the present technology;

FIG. 4 illustrates an example of a system for a distributed blockchain for maintaining operator identifier information, in accordance with an embodiment of the present technology;

FIG. 5 illustrates an example of a method for maintaining operator identifier information, in accordance with an embodiment of the present technology;

FIG. 6 is an illustration of example networks that may utilize and/or implement at least a portion of the techniques presented herein;

FIG. 7 is an illustration of a scenario involving an example configuration of a computer that may utilize and/or implement at least a portion of the techniques presented herein;

FIG. 8 is an illustration of a scenario involving an example configuration of a client that may utilize and/or implement at least a portion of the techniques presented herein;

FIG. 9 is an illustration of a scenario featuring an example non-transitory machine readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof. The following provides a discussion of some types of computing scenarios in which the disclosed subject matter may be utilized and/or implemented.

Systems and methods are provided for a distributed blockchain maintaining operator identifier information. A network operator may provide user equipment with voice and data capabilities over a network. A user may have a subscription plan with the network operator for user equipment, such as a mobile phone, a smart watch, or other device, so that the user equipment can successfully connect to and utilize the network. The network operator may track network behavior, network traffic of voice and data being routed through the network, and/or other network information related to the network. The network information may be leveraged by applications hosted by the user equipment. The applications can then be implemented as network aware applications that can perform network aware optimizations. Accordingly, the network operator may create network application programming interfaces (APIs) that provide network information and/or other information or services based upon the network information. For example, an anti-fraud API may be hosted by the network operator. An application executing on user equipment (e.g., a banking app on a mobile phone) may make an API call to the anti-fraud API in order to perform member verification for a user attempting to log into the application.

Network APIs may be exposed by network operators to user equipment through an aggregator. The aggregator is capable of standardizing the network APIs for use by customers of different network operators. There may be multiple different network operators that have their own customers that utilize user equipment registered with a particular network operator to which a customer is subscribed. The customers of these various network operators may utilize the user equipment to request access to the network APIs. Accordingly, the aggregator needs the ability to identify a network operator associated with a mobile device number or internet protocol (IP) address of user equipment requesting access to a network API. This is because the aggregator is to route the API request, received from the user equipment, to a network operator gateway of a corresponding network operator that hosts the network API being requested, as opposed to routing the API request to a different network operator to which the user equipment is not subscribed.

Aggregators lack a centralized mechanism to efficiently track and determine how to route API calls from user equipment to the correct network operators. An aggregator would have to perform multiple calls to each network operator to determine if a mobile device number or IP address of user equipment belongs to a particular network operator and/or to retrieve the corresponding mobile code information, such as a mobile country code (MCC) and a mobile network code (MNC). Making multiple calls to each network operator is time-consuming, inefficient, and consumes a significant amount of bandwidth, especially at scale where millions of user equipment may be accessing the aggregator for accessing network APIs.

The disclosed techniques provide for a distributed blockchain used to maintain operator identifier information. The operator identifier information is used by an aggregator to route API requests to corresponding network operators hosting network APIs targeted by the API requests. The blockchain is composed of nodes representing or managed by different network operators. The blockchain stores the operator identifier information within the blocks that can be quickly and efficiently provided to the aggregator. In particular, the aggregator is capable of obtaining operator identifier information that identifies a network operator to which an API request is to be routed. The operator identifier information may be obtained by the aggregator using a single call to the blockchain, as opposed to separately calling each network operator to determine whether the network operator hosts the network API targeted by the API request.

Each network operator can submit transactions to the blockchain to create/update the operator identifier information that maps mobile code information (e.g., MCC/MNC) with user equipment identifier information (e.g., a mobile device number or IP address). When the aggregator receives an API request from user equipment having a service subscription plan with a particular network operator, the aggregator queries a node within the blockchain (e.g., a geographically closest node, a node selected using load balancing functionality, a node having up-to-date cached data, etc.) using user equipment identifier information specified by the API request. The node returns the corresponding mobile code information, mapped to the user equipment identifier information, to the aggregator. In this way, the aggregator can quickly and efficiently identify the network operator from the mobile code information, and routes the API request to the network operator that invokes the network API to perform certain functionality such as fraud detection or network optimization functionality.

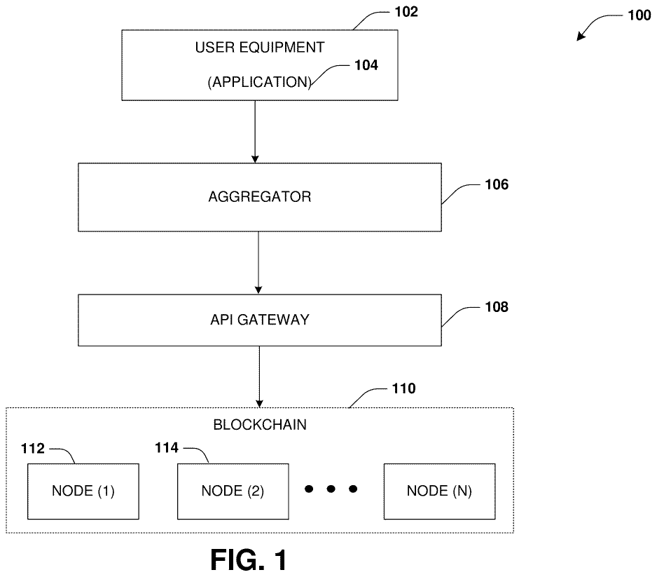

FIG. 1 illustrates an example of a system 100 for a blockchain 110 that maintains operator identifier information. The blockchain 110 may be composed of nodes representing or managed by network operators such as a first node 112 representing a first network operator, a second node 114 representing a second network operator, and/or other nodes of network operators that may manage network(s) providing user equipment with voice, data, and/or other capabilities over the network(s). Each network operator may service their own set of user equipment, such as mobile devices of users that have service subscriptions with a particular network operator (e.g., users may have cellular and/or data plans for phones, watches, and/or other devices with communication capabilities). The nodes, representing the network operators, form the blockchain 110. In some embodiments, the nodes may be located within different geographical regions (e.g., some nodes and network operators may be located in a certain country, while other nodes and network operators may be located in a different country).

The network operators may generate, execute, and validate transactions against the blockchain 110. The transactions are executed to store operator identifier information such as mappings between mobile code information (e.g., MMC/MNC) and user equipment identifier information (e.g., mobile device numbers and IP addresses of user equipment). Because the operator identifier information is easily accessible to an aggregator 106 through an API gateway 108, the aggregator 106 may quickly and efficiently obtain operator identifier information used to determine how to route an API request from an application 104 of user equipment 102 to a corresponding network operator hosting a network API being requested by the API request.

In some embodiments, the aggregator 106 may receive the API request specifying a user equipment identifier such as a mobile device number or IP address of the user equipment. In some embodiments, the aggregator 106, utilizing the API gateway 108, identifies a node based upon proximity (e.g., a geographically closest node). In some embodiments, the node is identified using load balancing functionality (e.g., a node with a smaller load than other nodes). In some embodiments, the node is identified based upon cache freshness (e.g., a node is identified by analytics as having up-to-date operator identifier information within a cache). A request is routed by the aggregator 106 through the API gateway 108 to the node. The request includes the user equipment identifier. In some embodiments, the node (a network operator managing the node) may utilize an index to help identify block locations and/or transactions within the blockchain 110 that may store corresponding mobile code information for the user equipment identifier. In some embodiments, the node (the network operator managing the node) may utilize a cache for processing the request. Once the corresponding mobile code information (e.g., MMC/MNC) has been located, the mobile code information is returned to the aggregator 106 for routing the API request from the application 104 to the correct network operator for calling the network API.

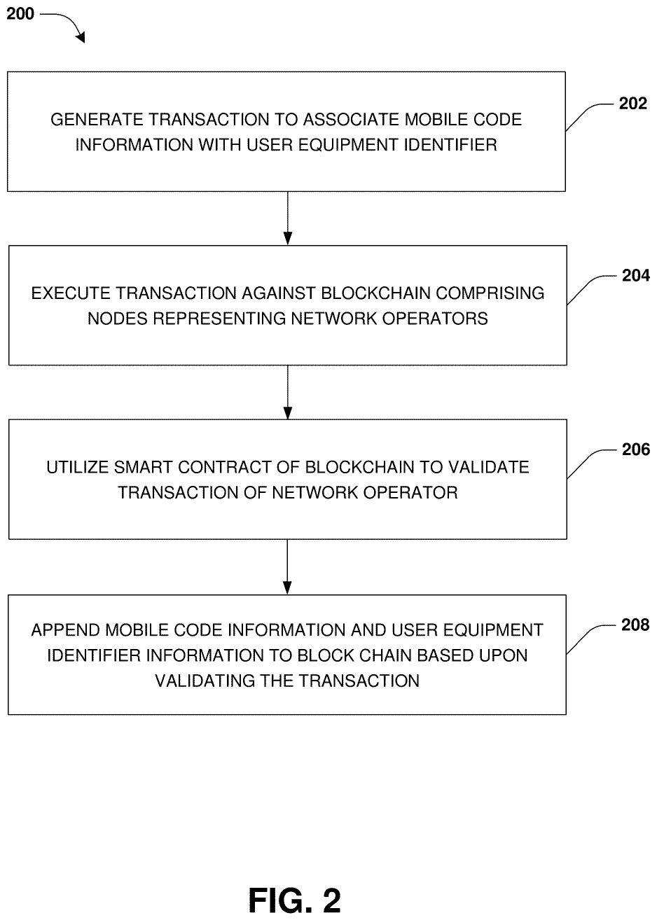

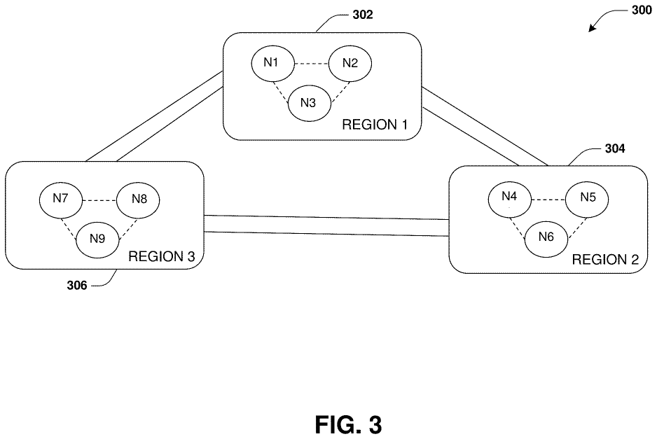

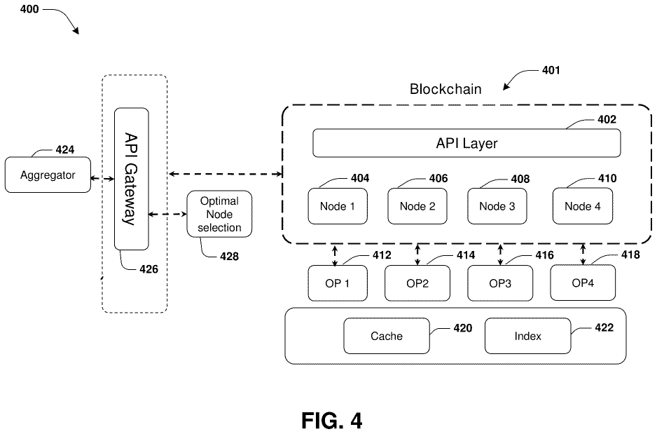

FIG. 2 illustrates an example of a method 200 for maintaining operator identifier information, which is described in conjunction with system 300 of FIG. 3 and system 400 of FIG. 4. Network operators may maintain nodes that form a blockchain of nodes. The nodes may be distributed across different geographical regions, as illustrated by FIG. 4. A first node of a first network operator, a second node of a second network operator, and a third node of a third network operator may be located within a first region 302. A fourth node of a fourth network operator, a fifth node of a fifth network operator, and a sixth node of a sixth network operator may be located within a second region 304. A seventh node of a seventh network operator, an eighth node of an eighth network operator, and a ninth node of a ninth network operator may be located within a third region 306. In some embodiments, a network operator may provide user equipment with communication capabilities over a network, and an aggregator, such as the aggregator 424 of FIG. 4, may be a unified communications service provider that may collaborate with network operators of different networks to form a unified/universal network service.

The nodes of system 400 may form a distributed blockchain, such as where a first node 404, a second node 406, a third node 408, a fourth node 410, and/or other nodes form a blockchain 401. The nodes may be accessible through an API layer 402. Thus, the aggregator 424 can access the nodes through an API gateway 426 (a distributed gateway) connected to the blockchain 401 through the API layer 402. Each node may represent or be managed by a network operator. For example, a first network operator 412 manages the first node 404, a second network operator 414 manages the second node 406, a third network operator 416 manages the third node 408, and a fourth network operator 418 manages a fourth node 410. A node of a network operator may host an API server that provides user equipment, of users subscribed to the network operator, with functionality of network APIs hosted by the network operator.

The network operators may generate, perform, and validate transactions to update the nodes with operator identifier information, such as mappings between mobile code information (e.g., MMC/MNC codes) and user equipment identifier information (e.g., mobile device numbers and/or IP addresses of user equipment). During operation 202 of method 200, a network operator generates a transaction to associate mobile code information with user equipment identifier information. The transaction may include a mobile number prefix field used to store a prefix or first few digits of a mobile number range to categorize transactions. The transaction may include a mobile country code field within which an MCC, associated with the network operator, is populated. The transaction may include a mobile network code field within which a MNC, associated with the network operator, is populated. The transaction may include a timestamp field populated with a time at which the transaction is added to the blockchain 401. The transaction may include a validity field corresponding to an effective start date of an MCC/MNC assignment. The transaction may include other fields. The transaction may represent an update or confirmation of MCC and MNC details for a specific range of mobile numbers.

During operation 204 of method 200, the transaction is executed against the blockchain 401 such as to append the mobile code information and/or the user equipment identifier information as operator identifier information into a block. During operation 206 of method 200, a smart contract of the blockchain 401 may be used to validate the transaction as being non-overlapping with mobile code information and user equipment identifier information stored within blocks in the blockchain 401 by other network operators represented by the other nodes of the blockchain 401. The transaction may be failed if an MCC, MNC, IP address, and/or mobile device number specified by the transaction are already stored within the blockchain 401 with respect to other network operators. In some embodiments, smart contracts are used to manage read and write permissions. A smart contract may specify which network operators are allowed to access operator identifier information of a particular network operator, such as where a network operator is allowed to read but not write to mobile code information stored within the blockchain 401. In some embodiments, a consensus mechanism is implemented for the blockchain. Network operators may be treated by the consensus mechanism as being partially trusted by other network operators. Accordingly, the consensus mechanism is implemented for the nodes to vote as to whether the block is to be added to the blockchain 401 or not.

During operation 208 of method 200, the mobile code information and/or the user equipment identifier information is appended to the blockchain based upon the transaction being validated. The mobile code information and/or the user equipment identifier information may be stored into a block for access by the aggregator 424 for determining how to route API requests to network operators. In some embodiments, the block is populated with a previous hash field (e.g., a hash of a previous block, which is used for integrity checking). In some embodiments, the block is populated with a transactions field (e.g., a list of transactions storing data in the block). In some embodiments, the block is populated with a nonce field (e.g., a field used for a mining process to mine information from the blockchain 401). In some embodiments, the block is populated with a timestamp field (e.g., a time when the block was mined). The block may be populated with other fields. Blocks may contain batches of transactions, and timestamps are assigned at a block level to help identify the latest updates to the blockchain 401 or a block therein.

In some embodiments, the network operator generates a validation transaction for the mobile code information and/or the user equipment identifier information that was appended to the blockchain 401. The validation transaction may be executed to validate that the mobile code information is linked for the network operator to the user equipment identifier information.

In some embodiments, a network operator may maintain an index 422 and/or a cache 420, which may be used to process requests from the aggregator 424 for mobile code information used by the aggregator 424 to route API requests to corresponding network operators. In some embodiments, the cache 420 and/or the index 422 may be hosted within a database, such as a database external to the blockchain 401. In some embodiments, the index 422 is used by the network operator to map user equipment identifiers to block locations of blocks within the blockchain 401. A block location may correspond to a block storing MCC/MNC information associated with a user equipment identifier. A prefix search may be performed against the index such as by using a prefix of a user equipment identifier to identify a block location of a user equipment identifier mapped to corresponding mobile code information. In this way, the corresponding mobile code information may be identified and provided to the aggregator 424 for routing an API request to a network operator associated with the corresponding mobile code information.

In some embodiments, the index may be queried to identify one or more relevant transactions associated with a request from the aggregator 424. Information about the one or more relevant transactions may be used to query the blockchain 401 to fetch the requested data that is returned to the aggregator 424. In some embodiments, the index 422 is used by the network operator to map user equipment identifiers to transactions committed to the blockchain 401. A prefix search may be performed against the index such as by using a prefix of a user equipment identifier to identify a transaction associated with corresponding mobile code information. In this way, the corresponding mobile code information may be identified and provided to the aggregator 424 for routing an API request to a network operator associated with the corresponding mobile code information.

In some embodiments, a network operator may maintain a cache populated with frequently accessed operator identifier information, such as frequently accessed mobile code information and/or user equipment identifier information. The frequently accessed operator identifier information may be identified using query analytics (e.g., an MCC may be frequently accessed when more than a threshold number of queries within a timespan retrieve the MCC). The network operator (or node of the network operator) may utilize the cache to quickly respond to requests from the aggregator 424 for operator identifier information. In some embodiments, the cache may be refreshed based upon timestamps associated with the mobile code information and/or user equipment identifier information, which may be indicative of a recency of such information. In some embodiments, the cache may be refreshed based upon validity fields within transactions committed to the blockchain, where a validity field may specify an effective start date of an MCC/MNC assignment by a network operator.

The aggregator 424 may receive an API request from an application hosted on user equipment (e.g., a user attempting to log into a banking app). The banking app may want to verify as to whether the user is logging into the banking app from user equipment owned by the user (e.g., a mobile phone of the user) or some other device (e.g., a public computer). The aggregator 424 may send a request through the API gateway 426 to the API layer 402 for routing to a node. The node may process the request to identify corresponding mobile code information that can be used to determine which network operator is to process the API request. The request may include a user equipment identifier such as a mobile device number and/or an IP address of the user equipment. The request may be for mobile code information, such as MCC/MNC, that is mapped to the user equipment identifier by a block within the blockchain 401.

The API gateway 426 may utilize node selection functionality 428 to determine how to route the request to a particular node for processing. The node selection functionality 428 may implement load balancing in order to route the request to a node with more available compute resources than other nodes. The node selection functionality 428 may route the request to a node that is more geographically proximate to the aggregator 424 than other nodes since nodes of the blockchain 401 may be spread across various regions and countries. Routing the request to the more geographically proximate node may reduce network latency and improve performance. The node selection functionality 428 may route the request to a node that is identified as having more up-to-date cached data than other nodes.

When the node receives the request from the aggregator 424, blocks within the blockchain 401 are evaluated using the user equipment identifier to identify corresponding mobile code information of a network operator associated with the user equipment identifier and the mobile code information. In this way, the corresponding mobile code information is provided back to the aggregator 424 as a response. The aggregator 424 may route the API request to a network operator gateway of the network operator associated with corresponding mobile code information. In this way, a network API of the network operator can process the API request, such as by determining whether the user is associated with (owns or registered with) the user equipment for verification/validation.

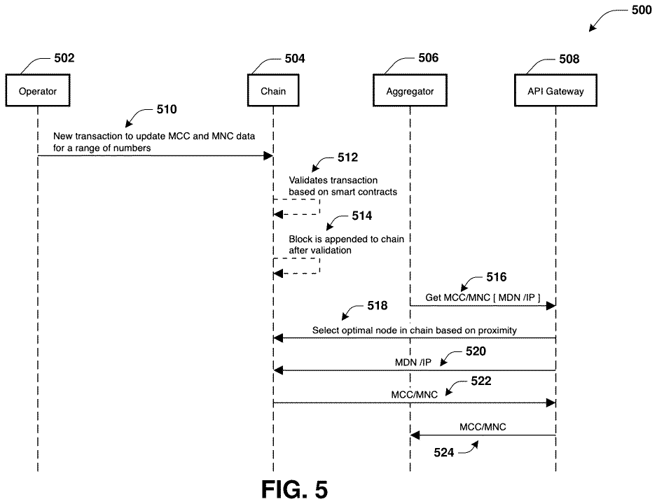

FIG. 5 illustrates an example of a method 500 for maintaining operator identifier information. A network operator 502 may maintain a node within a blockchain 504. The network operator 502 may generate a transaction that is executed against the blockchain 504 to update/add operator identifier information, such as to update MCC and MNC data for a range of user equipment identifiers, during operation 510. The blockchain 504 may validate the transaction using smart contracts of the blockchain 504, during operation 512. Once the transaction is validated, a block is appended to the blockchain 504 with information from the request (e.g., a mapping between the MCC and MNC data and the range of user equipment identifiers), during operation 514.

An aggregator 506 may receive an API request from user equipment. The API request is to be routed by the aggregator 506 to a network operator hosting a network API that can process the API request. Accordingly, the aggregator 506 sends a request to an API gateway 508 for routing to a node that can identify MCC/MNC data mapped to a user equipment identifier associated with the user equipment that sent the API request to the aggregator 506, during operation 516. The API gateway 508 may selectively route the request to a particular node within the blockchain 504 (e.g., a more geographically proximate node, a node with available resources, a node with up-to-date cached information), during operation 518. The API gateway 508 may route the request, with the user equipment identifier (e.g., mobile device number and/or IP address), to the node, during operation 520. The node may evaluate the blockchain to extract corresponding mobile code information such as MCC/MNC data mapped to the user equipment identifier. The node may return the corresponding mobile code information to the API gateway 508, during operation 522. The API gateway 508 may return the corresponding mobile code information to the aggregator 506, during operation 524. In this way, the aggregator 506 may identify the network operator associated with the corresponding mobile code information so that the API request can be routed to the network operator.

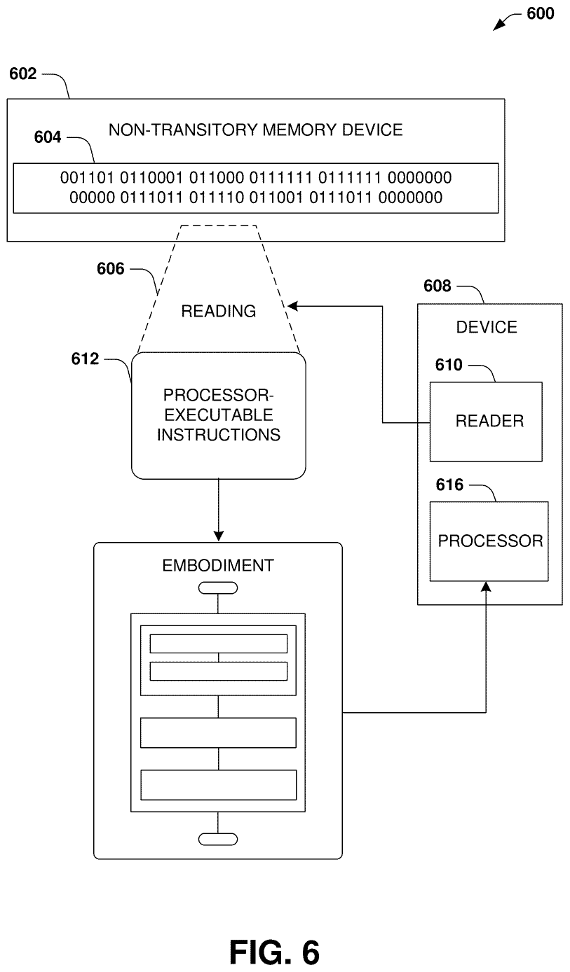

FIG. 6 is an illustration of a scenario 600 involving an example non-transitory machine readable medium 602. The non-transitory machine readable medium 602 may comprise processor-executable instructions 612 that when executed by a processor 616 cause performance (e.g., by the processor 616) of at least some of the provisions herein. The non-transitory machine readable medium 602 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 602 stores computer-readable data 604 that, when subjected to reading 606 by a reader 610 of a device 608 (e.g., a read head of a hard disk drive, or a read operation invoked on a solid-state storage device), express the processor-executable instructions 612. In some embodiments, the processor-executable instructions 612, when executed cause performance of operations, such as at least some of the example method 200 of FIG. 2, for example. In some embodiments, the processor-executable instructions 612 are configured to cause implementation of a system, such as at least some of the example system 100 of FIG. 1, at least some of the example system 300 of FIG. 3, at least some of the example system 400 of FIG. 4, for example.

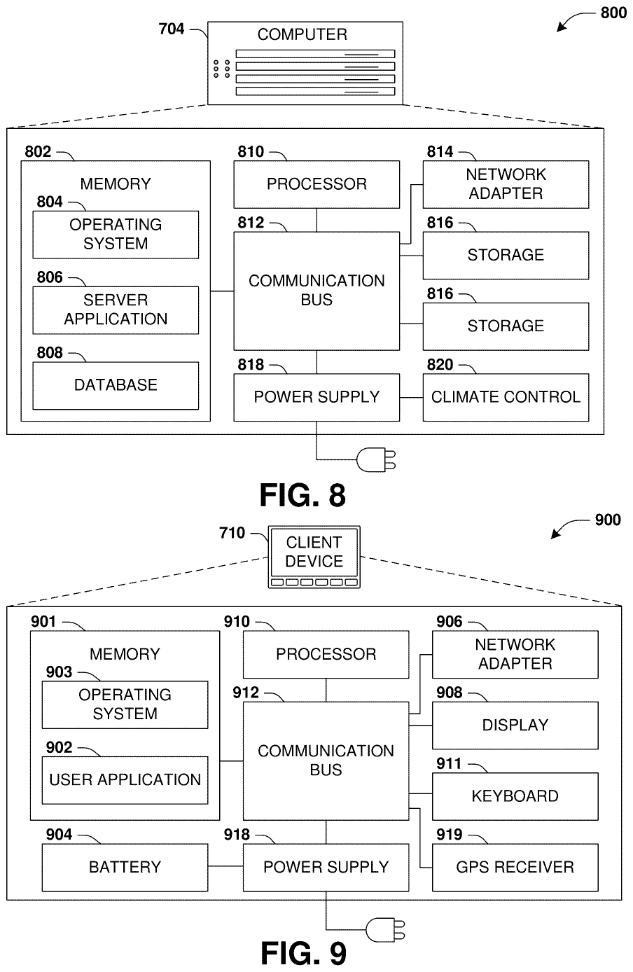

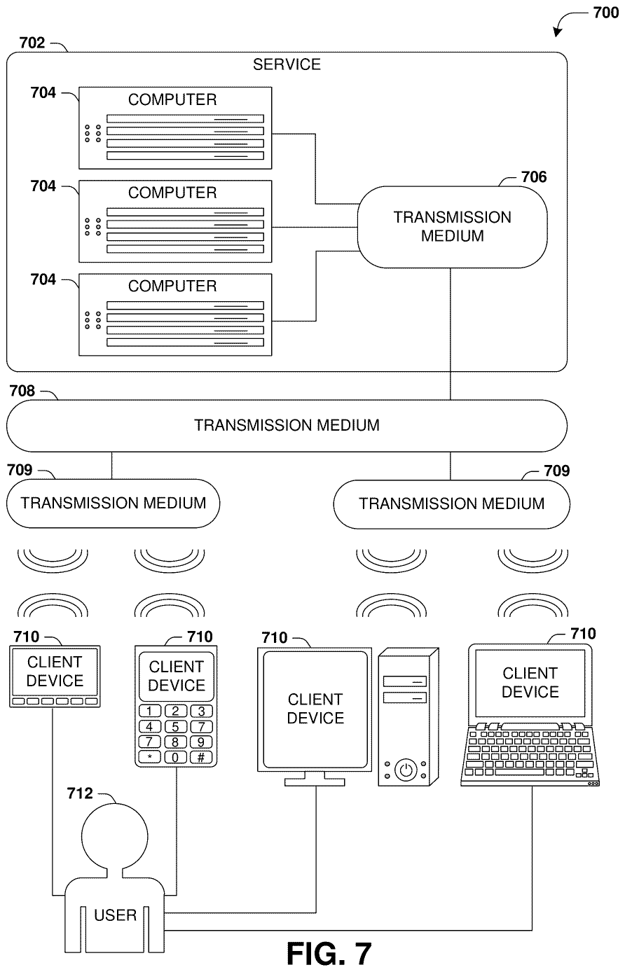

FIG. 7 is an interaction diagram of a scenario 700 illustrating a service 702 provided by a set of computers 704 to a set of client devices 710 via various types of transmission mediums. The computers 704 and/or client devices 710 may be capable of transmitting, receiving, processing, and/or storing many types of signals, such as in memory as physical memory states.

In some embodiments, the computers 704 may be host devices and/or the client device 710 may be devices attempting to communicate with the computer 704 over buses for which device authentication for bus communication is implemented.

The computers 704 of the service 702 may be communicatively coupled together, such as for exchange of communications using a transmission medium 706. The transmission medium 706 may be organized according to one or more network architectures, such as computer/client, peer-to-peer, and/or mesh architectures, and/or a variety of roles, such as administrative computers, authentication computers, security monitor computers, data stores for objects such as files and databases, business logic computers, time synchronization computers, and/or front-end computers providing a user-facing interface for the service 702.

Likewise, the transmission medium 706 may comprise one or more sub-networks, such as may employ different architectures, may be compliant or compatible with differing protocols and/or may interoperate within the transmission medium 706. Additionally, various types of transmission medium 706 may be interconnected (e.g., a router may provide a link between otherwise separate and independent transmission medium 706).

In scenario 700 of FIG. 7, the transmission medium 706 of the service 702 is connected to a transmission medium 708 that allows the service 702 to exchange data with other services 702 and/or client devices 710. The transmission medium 708 may encompass various combinations of devices with varying levels of distribution and exposure, such as a public wide-area network and/or a private network (e.g., a virtual private network (VPN) of a distributed enterprise).

In the scenario 700 of FIG. 7, the service 702 may be accessed via the transmission medium 708 by a user 712 of one or more client devices 710, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 710 may communicate with the service 702 via various communicative couplings to the transmission medium 708. As a first such example, one or more client devices 710 may comprise a cellular communicator and may communicate with the service 702 by connecting to the transmission medium 708 via a transmission medium 709 provided by a cellular provider. As a second such example, one or more client devices 710 may communicate with the service 702 by connecting to the transmission medium 708 via a transmission medium 709 provided by a location such as the user's home or workplace (e.g., a Wi-Fi (Institute of Electrical and Electronics Engineers (IEEE) Standard 802.11) network or a Bluetooth (IEEE Standard 802.15.1) personal area network). In this manner, the computers 704 and the client devices 710 may communicate over various types of transmission mediums.

FIG. 8 presents a schematic architecture diagram 800 of a computer 804 that may utilize at least a portion of the techniques provided herein. Such a computer 804 may vary widely in configuration or capabilities, alone or in conjunction with other computers, in order to provide a service.

The computer 804 may comprise one or more processors 810 that process instructions. The one or more processors 810 may optionally include a plurality of cores; one or more coprocessors, such as a mathematics coprocessor or an integrated graphical processing unit (GPU); and/or one or more layers of local cache memory. The computer 804 may comprise memory 802 storing various forms of applications, such as an operating system 804; one or more computer applications 806; and/or various forms of data, such as a database 808 or a file system. The computer 804 may comprise a variety of peripheral components, such as a wired and/or wireless network adapter 814 connectible to a local area network and/or wide area network; one or more storage components 816, such as a hard disk drive, a solid-state storage device (SSD), a flash memory device, and/or a magnetic and/or optical disk reader.

The computer 804 may comprise a mainboard featuring one or more communication buses 812 that interconnect the processor 810, the memory 802, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 812 may interconnect the computer 804 with at least one other computer. Other components that may optionally be included with the computer 804 (though not shown in the schematic architecture diagram 800 of FIG. 8) include a display; a display adapter, such as a graphical processing unit (GPU); input peripherals, such as a keyboard and/or mouse; and a flash memory device that may store a basic input/output system (BIOS) routine that facilitates booting the computer 804 to a state of readiness.

The computer 804 may operate in various physical enclosures, such as a desktop or tower, and/or may be integrated with a display as an “all-in-one” device. The computer 804 may be mounted horizontally and/or in a cabinet or rack, and/or may simply comprise an interconnected set of components. The computer 804 may comprise a dedicated and/or shared power supply 818 that supplies and/or regulates power for the other components. The computer 804 may provide power to and/or receive power from another computer and/or other devices. The computer 804 may comprise a shared and/or dedicated climate control unit 820 that regulates climate properties, such as temperature, humidity, and/or airflow. Many such computers 804 may be configured and/or adapted to utilize at least a portion of the techniques presented herein.

FIG. 9 presents a schematic architecture diagram 900 of a client device 710 whereupon at least a portion of the techniques presented herein may be implemented. Such a client device 710 may vary widely in configuration or capabilities, in order to provide a variety of functionality to a user such as the user 712. The client device 710 may be provided in a variety of form factors, such as a desktop or tower workstation; an “all-in-one” device integrated with a display 908; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 710 may serve the user in a variety of roles, such as a workstation, kiosk, media player, gaming device, and/or appliance.

The client device 710 may comprise one or more processors 910 that process instructions. The one or more processors 910 may optionally include a plurality of cores; one or more coprocessors, such as a mathematics coprocessor or an integrated graphical processing unit (GPU); and/or one or more layers of local cache memory. The client device 710 may comprise memory 901 storing various forms of applications, such as an operating system 903; one or more user applications 902, such as document applications, media applications, file and/or data access applications, communication applications such as web browsers and/or email clients, utilities, and/or games; and/or drivers for various peripherals. The client device 710 may comprise a variety of peripheral components, such as a wired and/or wireless network adapter 906 connectible to a local area network and/or wide area network; one or more output components, such as a display 908 coupled with a display adapter (optionally including a graphical processing unit (GPU)), a sound adapter coupled with a speaker, and/or a printer; input devices for receiving input from the user, such as a keyboard 911, a mouse, a microphone, a camera, and/or a touch-sensitive component of the display 908; and/or environmental sensors, such as a global positioning system (GPS) receiver 919 that detects the location, velocity, and/or acceleration of the client device 710, a compass, accelerometer, and/or gyroscope that detects a physical orientation of the client device 710. Other components that may optionally be included with the client device 710 (though not shown in the schematic architecture diagram 900 of FIG. 9) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 710 to a state of readiness; and a climate control unit that regulates climate properties, such as temperature, humidity, and airflow.

The client device 710 may comprise a mainboard featuring one or more communication buses 912 that interconnect the processor 910, the memory 901, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 710 may comprise a dedicated and/or shared power supply 918 that supplies and/or regulates power for other components, and/or a battery 904 that stores power for use while the client device 710 is not connected to a power source via the power supply 918. The client device 710 may provide power to and/or receive power from other client devices.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

What is claimed:

1. A method, comprising:
generating, by a network operator, a transaction to associate mobile code information with user equipment identifier information;
executing the transaction against a blockchain comprising nodes representing network operators, wherein a node hosts an application programming interface (API) server of the network operator for providing users of the network operator with functionality of an API hosted by the network operator;
utilizing a smart contract of the blockchain to validate the transaction of the network operator as being non-overlapping with mobile code information and user equipment identifier information of other network operators represented by the nodes of the blockchain; and
in response to validating the transaction, appending the mobile code information and the user equipment identifier information to the blockchain for access by an aggregator for determining how to route API requests to network operators.

2. The method of claim 1, comprising:
generating, by the network operator, a validation transaction for the mobile code information and the user equipment identifier information appended to the blockchain; and
executing the validation transaction to validate that the mobile code information as being linked to the user equipment identifier information.

3. The method of claim 1, comprising:
receiving, by the node from the aggregator through an API gateway, a request comprising a user equipment identifier, wherein the user equipment identifier comprises at least one of a mobile device number or an internet protocol (IP) address, and wherein the request is for corresponding mobile code information comprising at least one of a mobile country code or a mobile network code;
evaluating blocks within the blockchain using the user equipment identifier to identify the corresponding mobile code information of the network operator associated with the user equipment identifier and the corresponding mobile code information; and
transmitting, by the node, a response through the API gateway to the aggregator, wherein the response comprises the corresponding mobile code information.

4. The method of claim 3, wherein the request is routed to the node selected by the API gateway based upon a proximity of the node in to the aggregator.

5. The method of claim 3, wherein the request is routed to the node selected by the API gateway based upon a load of the node in relation to loads of other nodes within the blockchain.

6. The method of claim 3, wherein the request is routed to the node selected by the API gateway based upon how up-to-date is information cached by the node in relation to other nodes within the blockchain.

7. The method of claim 1, comprising:
maintaining, by the network operator, an index that maps user equipment identifiers to block locations within the blockchain; and
performing a prefix search against the index to identify a block location of a user equipment identifier mapped to corresponding mobile code information to provide to the aggregator.

8. The method of claim 1, comprising:
maintaining, by the network operator, an index that maps user equipment identifiers to transactions committed to the blockchain; and
performing a prefix search against the index to identify a transaction associated with corresponding mobile code information to provide to the aggregator.

9. A system, comprising:
one or more processors configured for executing instructions to perform operations comprising:
generating, by a network operator, a transaction to associate mobile code information with user equipment identifier information;
executing the transaction against a blockchain comprising nodes representing network operators, wherein a node hosts an application programming interface (API) server of the network operator for providing users of the network operator with functionality of an API hosted by the network operator;
utilizing a smart contract of the blockchain to validate the transaction of the network operator as being non-overlapping with mobile code information and user equipment identifier information of other network operators represented by the nodes of the blockchain; and
in response to validating the transaction, appending the mobile code information and the user equipment identifier information to the blockchain for access by an aggregator for determining how to route API requests to network operators.

10. The system of claim 9, wherein the operations further comprise:
maintaining, by the network operator, a cache populated with frequently accessed mobile code information and user equipment identifier information identified based upon query analytics, wherein the node responds to requests from the aggregator utilizing the cache.

11. The system of claim 10, wherein the operations further comprise:
refreshing the cache based upon timestamps associated with the mobile code information and the user equipment identifier information.

12. The system of claim 10, wherein the operations further comprise:
refreshing the cache based upon validity fields within transactions committed to the blockchain.

13. The system of claim 10, wherein the operations further comprise:
utilizing the smart contract to manage read and write permissions to prevent an unauthorized network operator within the blockchain from accessing the mobile code information.

14. The system of claim 10, wherein the operations further comprise:
implementing a consensus mechanism for the blockchain where network operators are partially trusted, wherein the consensus mechanism is implemented for the nodes to vote as to whether a block is to be added to the blockchain.

15. A non-transitory computer-readable medium storing instructions that when executed by one or more processors facilitate performance of operations comprising:
generating, by a network operator, a transaction to associate mobile code information with user equipment identifier information;
executing the transaction against a blockchain comprising nodes representing network operators, wherein a node hosts an application programming interface (API) server of the network operator for providing users of the network operator with functionality of an API hosted by the network operator;
utilizing a smart contract of the blockchain to validate the transaction of the network operator as being non-overlapping with mobile code information and user equipment identifier information of other network operators represented by the nodes of the blockchain; and
in response to validating the transaction, appending the mobile code information and the user equipment identifier information to the blockchain for access by an aggregator for determining how to route API requests to network operators.

16. The non-transitory computer-readable medium of claim 15, wherein the operations further comprise:
populating the transaction with a mobile number prefix field, a mobile country code field, a mobile network code field, a timestamp field, and a validity field.

17. The non-transitory computer-readable medium of claim 15, wherein the operations further comprise:
populating a block with a batch of transactions; and
assigning timestamps to blocks at a block level.

18. The non-transitory computer-readable medium of claim 15, wherein the operations further comprise:
populating a block with a previous hash field, a transactions field, a nonce field, and a timestamp field.

19. The non-transitory computer-readable medium of claim 15, wherein the operations further comprise:
maintaining an index that maps user equipment identifiers to block locations within the blockchain.

20. The non-transitory computer-readable medium of claim 19, wherein the operations further comprise:
querying the index to identify one or more relevant transactions associated with a request from the aggregator; and
utilizing information about the one or more relevant transactions to query to blockchain to fetch requested data to return to the aggregator.
